(19) United States
(12) Patent Application Publication
(10) Pub. No.: US 2022/0114232 A1
(43) Pub. Date: Apr. 14, 2022

(54) IMPUTATION METHOD AND ELECTRICAL DEVICE FOR SYMMETRIC AND NONNEGATIVE MATRIX

(71) Applicant: NATIONAL SUN YAT-SEN UNIVERSITY, KAOHSIUNG (TW)

(72) Inventor: Bo-Wei CHEN, KAOHSIUNG (TW)

(21) Appl. No.: 16/953,309

(22) Filed: Nov. 19, 2020

(30) Foreign Application Priority Data
Oct. 13, 2020 (TW) 109135380

(51) Int. Cl. G06F 17/16; G06F 7/50; G06F 1/03

(52) U.S. Cl. CPC G06F 17/16; G06F 1/03; G06F 7/50

(57) ABSTRACT

An imputation method for a nonnegative symmetric matrix includes: obtaining an input symmetric matrix which includes multiple continuous void values; taking a difference between the input symmetric matrix and a target matrix as an input of a half quadratic function to form an objective function; and performing an optimization algorithm based on the objective function to compute elements of the target matrix.

### RELATED APPLICATIONS

This application claims priority to Taiwan Application Serial Number 109135380 filed Oct. 13, 2020, which is herein incorporated by reference.

### BACKGROUND

### Field of Invention

The present disclosure relates to an imputation method for a symmetric and nonnegative matrix. More particularly, the present disclosure relates to the imputation method by taking a half quadratic function to form an objective function for an optimization algorithm.

### Description of Related Art

In the technical field of data processing, raw data is often expressed as a matrix, and this matrix may have null values. There are a few approaches to deal with a symmetric matrix containing null values such as: single value imputation, symmetric regression, Symmetric K-Nearest Neighbors (SKNNs), Latent Component-Based Methods and Symmetric Matrix Completion.

The approach of single value imputation is to fill a null-value entry with a fixed value such as a zero, a mean or a median. The disadvantage of this approach is losing discriminability. For example, the difference in height between men and women will be reduced when this approach is adopted.

The approach of symmetric regression is to ignore null values in dependent attributes and use data in complete independent attributes to build a regression model for an asymmetric matrix which is used to predict the null values. If two symmetric null values occur in the symmetric matrix, then mean of two predicted values is computed. The disadvantage of this approach is that if each attribute has some null values, a subset cannot be found in which all attributes contain complete data, and then the performance of the regression model will be reduced.

The approach of SKNNs needs to load a complete dataset. When a new sample with null values is input, the null values are ignored and other complete attributes are used to find K-nearest samples in the dataset. The attributes of the K-nearest samples are used to fill the null values of the new sample. If two symmetric null values occur in the symmetric matrix, then mean of two predicted values is computed. The disadvantage of this approach is that when the dataset contains a large amount of null values, the null values have to be filled in with initial values in advance which will reduce discriminability. In addition, if the dataset is huge, every time there is a new sample with null values, it is necessary to compute a distance from the entire dataset, which is quite time-consuming.

The approach of Latent Component-Based Methods is to perform Truncated Eigenvalue Decomposition on dataset having null values which are filled with initial values in advance. Replacement values are computed according to the eigenvectors until the process converges. The approach of Symmetric Matrix Completion such as Symmetric Nonnegative Matrix Factorization (SymNMF) is to divide a dataset with null values (which are filled with initial values in advance) into two identical factor matrices by principle of matrix decomposition. The factor matrices are constituted by linear composition of weight bases to predict the null values. The procedure repeats until the factor matrix converges. The disadvantage of these two approaches is that when continuous null values occur, the data cannot be effectively restored based on L₁ norm (i.e., Manhattan distance) or L₂ norm (i.e., Euclidean distance), and the error between the estimated value and the true value is large.

How to provide a better imputation method is a topic of concern to those people skilled in the art.

### SUMMARY

Embodiments of the present disclosure provide an imputation method for an electrical device. The imputation method includes: obtaining an input symmetric matrix which includes multiple continuous null values; taking a difference between the input symmetric matrix and a target matrix as an input of a half quadratic function to form an objective function; and performing an optimization algorithm according to the objective function to obtain the elements of the target matrix.

In some embodiments, the objective function is represented as the following equation (1).

$$\begin{matrix}min E = {min}_{0 ⪯ V ⪯ B} {\sum }_{n = 1}^{N} {\sum }_{m = 1}^{N} ϕ ( {( X - {V}^{T} V )}_{m , n} ) \\ = {min}_{0 ⪯ V ⪯ B} \{ {\sum }_{m = 1 , n = 1} ( {W}_{m , n} ⊙ {( X - {V}^{T} V )}_{m , n}^{2} + φ ( {W}_{m , n} ) ) \}\end{matrix} \qquad ( 1 )$$

X is the input symmetric matrix, V is an unknown matrix, V^{T}V is the target matrix, ϕ(⋅) is the half quadratic function, B is an upper bound, N is a positive integer, W is a matrix consisting of nonnegative auxiliary scalars, and the half quadratic function is selected from multiple candidate half quadratic functions.

In some embodiments, the imputation method further includes: fixing the unknown matrix V, and computing the matrix W according to a selected one of the candidate half quadratic functions by a lookup table approach; and in an iteration procedure, computing the unknown matrix V according to the following equation (2).

$${V}_{d , n} = med \{ θ , {V}_{d , n} ⊙ {( ( 1 - η ) {1}_{D \times N} + η \frac{V ( W ⊙ X )}{V ( W ⊙ ( {V}^{T} V ) )} )}_{d , n} , {B}_{d , n} \} \qquad ( 2 )$$

θ is a positive number, η is an iteration updating rate, and med(⋅) is a median function.

In some embodiments, the imputation method further includes: in each iteration of the iteration procedure, computing a matrix ν according to the equation (2), and computing a temporary error according to the input symmetric matrix X and a matrix ν^{T}ν; reducing an updating magnitude if the temporary error is greater than an error computed in a previous iteration.

In some embodiments, the imputation method further includes: fixing the unknown matrix V, and computing the matrix W according to a selected one of the candidate half quadratic functions by a lookup table approach; and in an iteration procedure, computing the unknown matrix V according to equations (3) and (4).

Δ=−4V(W⊙X)+4V(W⊙(V^{T}V)) (3)

V_{d,n}=med{θ,V_{d,n}−ζΔ_{d,n},B_{d,n}} (4)

ζ is an iteration updating rate.

In some embodiments, the objective function is represented as the following equation (5).

$$min E = {min}_{0 ⪯ U ⪯ A \\ 0 ⪯ V ⪯ B} \{ {\sum }_{n = 1}^{N} {\sum }_{m = 1}^{N} ϕ ( {( X - UV )}_{m , n} ) - λ {‖ {U}^{T} - V ‖}_{ℱ}^{2} \} \qquad ( 5 )$$

X is the input symmetric matrix, U and V are unknown matrices, UV is the target matrix, ϕ(⋅) is the half quadratic function, A and B are upper bounds, N is a positive integer, λ is a real number, and the half quadratic function is selected from multiple candidate half quadratic functions. The imputation method further includes: fixing the unknown matrix V, and computing a matrix W according to a selected one of the candidate half quadratic functions by a lookup table approach; and in an iteration procedure, computing the unknown matrix U and the unknown matrix V according to the following equations (6) and (7).

$$\begin{matrix}{U}_{n , d} = med \{ θ , {U}_{n , d} ⊙ \frac{{( ( X ⊙ W ) {V}^{T} + λ {V}^{T} )}_{n , d}}{{( ( \hat{X} ⊙ W ) {V}^{T} + λ U )}_{n , d}} , {A}_{n , d} \} & ( 6 ) \\ {V}_{d , n} = med \{ θ , {V}_{d , n} ⊙ \frac{{( {U}^{T} ( W ⊙ X ) + λ {U}^{T} )}_{d , n}}{{( {U}^{T} ( W ⊙ \hat{X} ) + λ V )}_{d , n}} , {B}_{d , n} \} . & ( 7 )\end{matrix}$$

From another aspect, embodiments of the present disclosure provide an electrical device including a memory storing multiple instructions and a processor configured to execute the instructions to perform steps of: obtaining an input symmetric matrix which includes multiple continuous null values; taking a difference between the input symmetric matrix and a target matrix as an input of a half quadratic function to form an objective function; and performing an optimization algorithm according to the objective function to obtain elements of the target matrix.

In the aforementioned imputation method, a half quadratic optimization is used to fill the continuous null values in the symmetric matrix. It can ensure that the error converges during iterations, so that the computation time is reduced.

### BRIEF DESCRIPTION OF THE DRAWINGS

The invention can be more fully understood by reading the following detailed description of the embodiment, with reference made to the accompanying drawings as follows.

FIG. 1 is a schematic diagram of an electrical device in accordance with an embodiment.

FIG. 2 is a diagram illustrating a RMSE curve with respect to iterations.

FIG. 3 is a diagram of a flow chart of an iteration procedure in accordance with a first embodiment.

FIG. 4 is a diagram illustrating a RMSE curve with respect to iterations.

FIG. 5A and FIG. 5B are diagrams of a main procedure in accordance with a second embodiment.

FIG. 6A and FIG. 6B are diagrams of a subprocedure in accordance with the second embodiment.

FIG. 7A and FIG. 7B are diagrams of a flow chart of an iteration procedure in accordance with a third embodiment.

### DETAILED DESCRIPTION

Specific embodiments of the present invention are further described in detail below with reference to the accompanying drawings; however, the embodiments described are not intended to limit the present invention and it is not intended for the description of operation to limit the order of implementation. Moreover, any device with equivalent functions that is produced from a structure formed by a recombination of elements shall fall within the scope of the present invention. Additionally, the drawings are only illustrative and are not drawn at actual size.

The using of “first”, “second”, “third”, etc. in the specification should be understood for identifying units or data described by the same terminology, but are not referred to particular order or sequence.

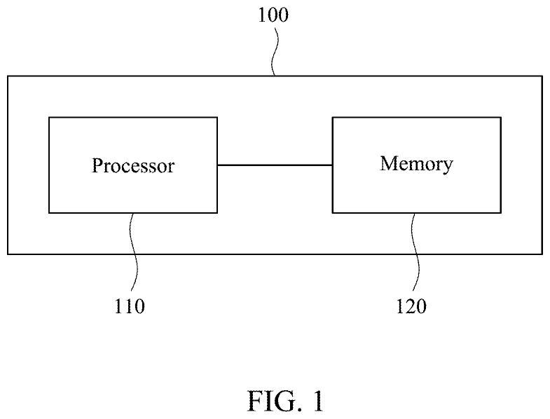

FIG. 1 is a schematic diagram of an electrical device in accordance with an embodiment. Referring to FIG. 1, an electric device 100 may be a smart phone, a tablet, a personal computer, a notebook computer, a server, an industrial computer, or any electric device having computing ability, which is not limited in the invention. The electrical device 100 includes a processor 110 and a memory 120 which is communicatively connected to the processor 110. The processor 110 may be a central processing unit, a microprocessor, a microcontroller, an application-specific integrated circuit, etc. The memory 120 may be a random access memory, a read-only memory, a flash memory, floppy disks, hard disks, CD-ROMs, pen drives, tapes, databases accessible via the Internet. The memory 120 stores instructions that are executed by the processor 110 to perform an imputation method which will be described in detail below.

Assume an industrial sensor database includes seven samples. For example, one sample per second is taken for seven seconds. Each sample includes five attributes that are temperature, humidity, pressure, concentration and exposure time. These samples can be represented as a matrix, of which the size is 7×5 as shown in the following Table 1. The matrix has some null values due to sensor failure. The null values are represented by gray blocks in Table 1.

When the matrix of Table 1 is transformed into a symmetric matrix such as Covariance Matrices, Similarity Matrices, Distance Matrices, Correlation Matrices, Adjacency Matrices, Between-Class/Within-Class Scatter Matrices, it produces continuous null values as shown in the following Table 2. The null values are represented by gray blocks. The first column and the first row represent the sample indices.

In the imputation method of the disclosure, an input symmetric matrix is obtained. The input symmetric matrix includes continuous null values as the matrix shown in Table 2. In some embodiments, the values of the input symmetric matrix are obtained by sensors, but these values may be related to sale data, health data, any product or any activity in other embodiments which are not limited in the disclosure. In the embodiment, a difference between the input symmetric matrix and a target matrix is taken as an input of a half quadratic function to form an objective function. An optimization algorithm is performed according to the objective function to obtain the elements of the target matrix. Three embodiments are provided herein. The first embodiment is based on a Gradient-Based Direct Method. The second embodiment is based on a Projected Gradient-Based Direct Method. The third embodiment is based on an Asymmetry Penalty Constrained Method. These three embodiments will be described in detail below.

### First Embodiment

Given an input symmetric matrix X, of which the size is N×N. The matrix has continuous null values which may be replaced with preset values (e.g., zeros) before the subsequent procedure. The aim is to find an unknown matrix V, of which the size is D×N, such that an error between a target matrix formed by V^{T}V and the matrix X is minimized, where N and D are positive integers. In other words, the target matrix V^{T}V is used to replace the matrix X or fill all the continuous null values in the matrix X. In the first embodiment, the objective function is written in the following equation (1).

$$min E = {min}_{0 ⪯ V ⪯ B} {\sum }_{n = 1}^{N} {\sum }_{m = 1}^{N} ϕ ( {( X - {V}^{T} V )}_{m , n} ) \qquad ( 1 )$$

In the equation (1), “T” indicates the transpose operator. 0 is a matrix consisting of zeros. B is an upper bound which may be defined by users. (⋅)_{m,n} indicates the element of the m-th row and n-th column in the corresponding matrix where m=1, . . . , N and n=1, . . . , N. “ [symbol] ” is elementwise operator of “less than or equal to” for matrices. The matrices X and V are nonnegative. ϕ(⋅) is a half quadratic function, of which the domain and the range are real numbers. The half quadratic function is differentiable and satisfies the conditions shown in equation (2) below.

$$\{ \begin{matrix}ϕ ( e ) \geq 0. \\ ϕ ( 0 ) \geq 0. \\ ϕ ( e ) = ϕ ( - e ) . \\ ϕ ( e ) \geq ϕ ( {e}^{′} ) , for \vert e \vert > \vert {e}^{′} \vert .\end{matrix} \qquad ( 2 )$$

In the equation (2), e and e′ are scalars of real numbers. |⋅| is the absolute operator. To solve the equation (1), the half quadratic optimization theory indicated that when ϕ(⋅) was replaced with an augmented HQ function, the solution to the original problem can be achieved by a two-step alternating optimization. The following equation (3) shows a general form of augmented Half Quadratic (HQ) functions for Correntropy Induced Metric (CIM) Nonnegative Matrix Factorization (NMF) and Huber NMF.

$$\begin{matrix}ϕ ( {e}_{m , n} ) = min \{ Quad ( {P}_{m , n} , {e}_{m , n} ) + φ ( {P}_{m , n} ) \} \\ = min \{ {P}_{m , n} {e}_{m , n}^{2} + φ ( {P}_{m , n} ) \} .\end{matrix} \qquad ( 3 )$$

Quad(⋅, ⋅) is a quadratic function. e_{m,n}=X_{m,n}−(V^{T}V)_{m,n}. P_{m,n} is an auxiliary scalar and nonnegative variable, and these auxiliary scalars constitute a matrix P, of which the size is N×N. φ(⋅) is a dual potential function of ϕ(⋅).

For Cauchy NMF and Truncated Cauchy NMF, the augmented HQ function is represented as the following equation (4).

$$\begin{matrix}ϕ ( {e}_{m , n} ) = max \{ {Q}_{m , n} {e}_{m , n}^{2} - φ ( {Q}_{m , n} ) \} \\ = - min \{ - {Q}_{m , n} {e}_{m , n}^{2} + φ ( {Q}_{m , n} ) \}\end{matrix} \qquad ( 4 )$$

Q_{m,n} is an auxiliary scalar and also is a nonpositive variable, and these variables constitute a matrix Q, of which the size is N×N. To simplify notations, the following discussion uses matrix W to represent matrices P or −Q, depending on whether W is for CIM NMF/Huber NMF or Cauchy NMF/Truncated Cauchy NMF. Thus, minimizers and maximizers can be both represented in the following equation (5) after substituting the equations (3) and (4) into the equation (1).

$$\begin{matrix}min E = {min}_{0 ⪯ V ⪯ B} {\sum }_{n = 1}^{N} {\sum }_{m = 1}^{N} ϕ ( {( X - {V}^{T} V )}_{m , n} ) \\ = {min}_{0 ⪯ V ⪯ B} \{ {\sum }_{m = 1 , n = 1} ( {W}_{m , n} ⊙ {( X - {V}^{T} V )}_{m , n}^{2} + φ ( {W}_{m , n} ) ) \}\end{matrix} \qquad ( 5 )$$

In the equation (5), ⊙ is elementwise multiplication. Finding the solution to the above equation relies on alternating optimization process between W and V. For optimizing W, solutions are listed in the following Table 3. In other words, the half quadratic function is selected from multiple candidate half quadratic functions. The candidate half quadratic functions and the corresponding auxiliary variables are shown in Table 3.

TABLE 3

| Name | ϕ(•) | Auxiliary Variable |
|---|---|---|
| Symmetric | ϕ(e_{m,n}) = (κ_{σ}(0) − κ_{σ}(e_{m,n})) | P_{m,n} = exp(−e_{m,n}²/(2σ²)) |
| CIM NMF | | |
| Symmetric Huber NMF | $ϕ ( {e}_{m , n} ) = \{ \begin{matrix}{e}_{m , n}^{2} , & if \vert {e}_{m , n} \vert \leq ϵ . \\ 2 ϵ \vert {e}_{m , n} \vert - {ϵ}^{2} , & otherwise .\end{matrix}$ | ${P}_{m , n} = \{ \begin{matrix}1 , & if \vert {e}_{m , n} \vert \leq ϵ . \\ ϵ / \vert {e}_{m , n} \vert , & otherwise .\end{matrix}$ |
| Symmetric Truncated Cauchy NMF | $ϕ ( {e}_{m , n} ) = \{ \begin{matrix}ln ( 1 + {( {e}_{m , n} / γ )}^{2} ) , & if \vert {e}_{m , n} \vert \leq ϵ . \\ ln ( 1 + {( ϵ / γ )}^{2} ) , & otherwise .\end{matrix}$ | ${Q}_{m , n} = \{ \begin{matrix}\frac{- 1}{1 + {( e / γ )}_{m , n}^{2}} , & if \vert {e}_{m , n} \vert \leq γ \sqrt{ϵ} . \\ 0 , & otherwise .\end{matrix}$ |
| Symmetric | ϕ(e_{m,n}) = ln(1 + (e_{m,n}/γ)²) | Q_{m,n} = −1/(1 + (e/γ)_{m,n}²) |
| Cauchy | | |
| NMF | | |

In Table 2, κ_{σ}(e_{m,n})=(2πσ)^{-1/2}exp(−e_{m,n}²/(2σ²)) is a kernel function for Correntropy Induced Metric functions. σ is the width of the kernel. ϵ is the cutoff. γ is the scale. The equation (5) includes two unknown matrices W and V. Alternating Least Squares (ALS) is used herein to solve the matrices W and V. First, the matrix V is fixed, then the matrix W (i.e., P or −Q) is computed according to the selected half quadratic function by looking up the function definition in Table 2. To solve the matrix V, the matrix W is fixed first, and then the gradient of the equation (5) with respect to V_{m,n} is computed based on the following equation (6).

$$\begin{matrix}\frac{\partial E}{\partial {V}_{d , n}} ≡ \frac{\partial }{\partial {V}_{d , n}} {\sum }_{m = 1 , n = 1} ( {W}_{m , n} ⊙ {( X - {V}^{T} V )}_{m , n}^{2} ) \\ = \frac{\partial }{\partial {V}_{d , n}} Tr ( ( {( X - {V}^{T} V )}^{T} ⊙ {\sqrt{W}}^{T} ) ( \sqrt{W} ⊙ ( X - {V}^{T} V ) ) ) \\ = 4 {( V ( W ⊙ ( {V}^{T} V ) ) - V ( W ⊙ X ) )}_{d , n}\end{matrix} \qquad ( 6 )$$

Tr(⋅) is the trace operator. \sqrt{W} is the elementwise squared root of the matrix W. Besides, this disclosure assumes W=W^{T} because X is symmetric. Iterations are performed to solve Box Constrained V_{d,n} which is updated based on the following equation (7).

$${V}_{d , n} = med \{ θ , {V}_{d , n} ⊙ {( ( 1 - η ) {1}_{D \times N} + η \frac{V ( W ⊙ X )}{V ( W ⊙ ( {V}^{T} V ) )} )}_{d , n} , {B}_{d , n} \} \qquad ( 7 )$$

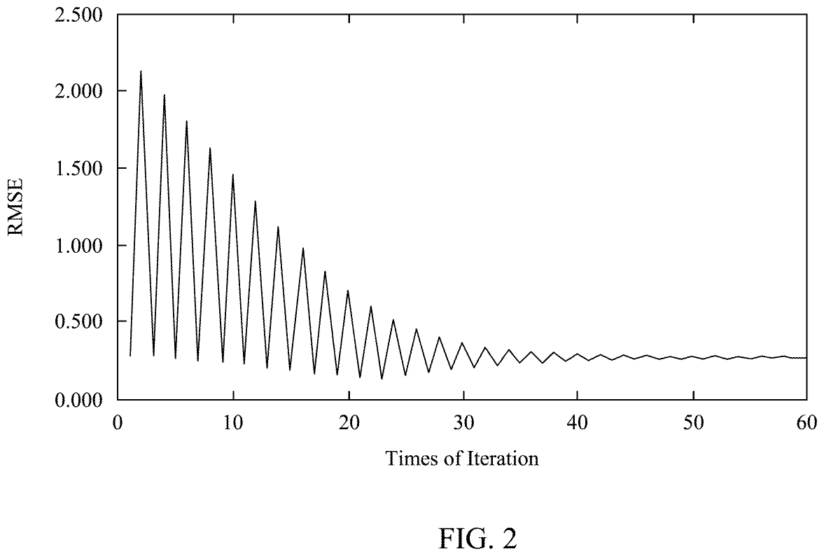

θ is a small positive number. η is an iteration updating rate (also referred to as a learning rate). 1_{D×N} represents a D×N matrix with all elements equal to ones. med(⋅) is a median function for selecting the median from three scalars. When the matrix B_{d,n} is not set, there is no upper bound. For convenience, a D×N matrix ∇ is used to represent the term ∇=V(W⊙X)/V(W⊙(V^{T}V)) with elementwise division. The matrix V also represents an updating magnitude of the matrix V. Herein, an iteration procedure is performed to update the unknown matrix V according to the equation (7). FIG. 2 is a diagram illustrating a Root Mean Square Error (RMSE) curve with respect to iterations. Referring to FIG. 2, the horizontal axis represents times of the iteration. The vertical axis represents the RMSE between the matrix X and the matrix V^{T}V. If Multiplicative Update Rules are directly used to compute the matrix V based on the equation (7), the RMSE oscillates without converging. To solve this problem, the embodiment proposes the Gradient-Based Direct Method. In each iteration of the iteration procedure, a matrix ν is computed according to the equation (7), and a temporary error is computed according to the input symmetric matrix X and the matrix ν^{T}ν. If the temporary error is greater than an error computed in the previous iteration, it means the error is increasing due to too much update, and therefore the updating magnitude of the matrix ν is reduced. To be specific, the iteration procedure of this embodiment is shown in the following Table 4.

TABLE 4
Gradient-Based Direct Method

| | Input: Symmetric matrix X |
|---|---|
| | Output: V |
| 1 | Initialize ν = V[0], ι=0 |
| 2 | Compute RMSE ε[0] between X and V[0]^{T}V[0] |
| 3 | Set ι=1 |
| 4 | Execute lines 5-15 until ι is greater than a preset value |
| 5 | Compute ∇ |
| 6 | Compute ν based on the equation (7) |
| 7 | Compute temporary RMSE ε′ based on X and ν^{T}ν |
| 8 | If ε′ > ε[ι−1] |
| 9 | Compute ν = V[ι] ⊙ ∇^{β} |
| 10 | Compute ε′ based on X and ν^{T}ν |
| 11 | If ε′ ≤ ε[ι−1] |
| 12 | V[ι] = ν |
| 13 | Compute ε[ι−1] based on X and V[ι]^{T}V[ι] |
| 14 | ε[ι] = ε[ι−1] and then ι = ι+ 1 |
| 15 | Back to line 4 |

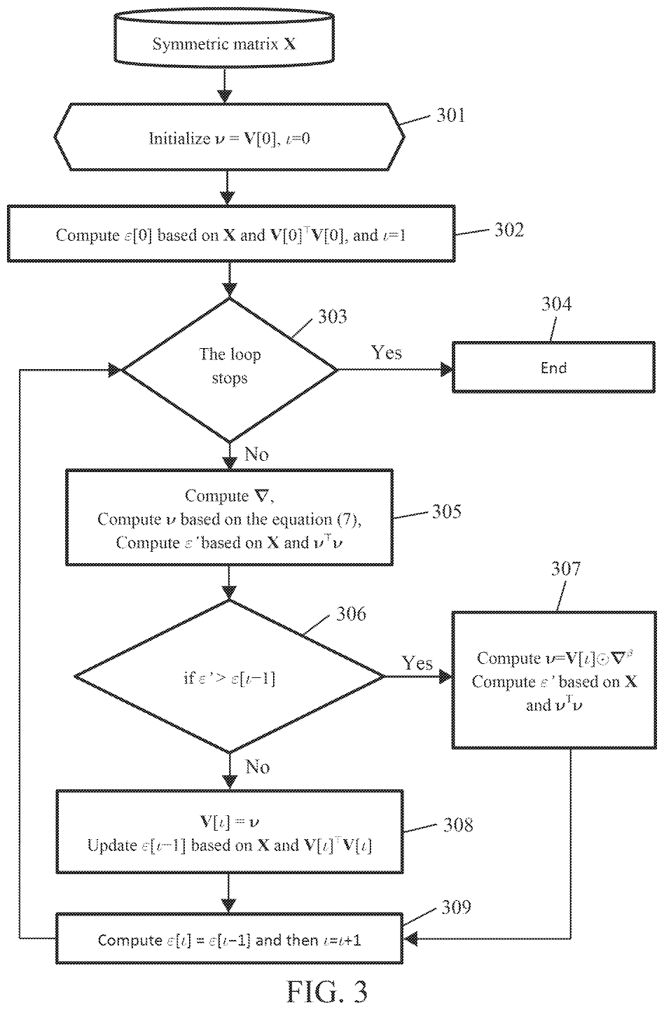

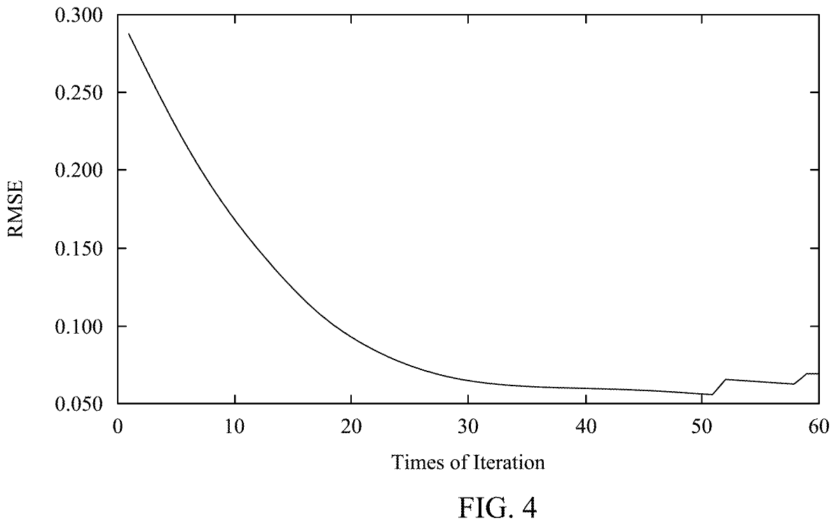

FIG. 3 is a diagram of a flow chart of an iteration procedure in accordance with the first embodiment. Referring to FIG. 3 and Table 4, [ι] is the ι-th iteration where ι is an integer. In step 301 (corresponding to the first line of Table 4), ν=V[0] and ι=0 are initialized. In step 302 (corresponding to lines 2-3 of Table 4), a RMSE ε[0] is computed based on the matrix X and V[0]^{T}V[0], and ι=1 is set. In step 303 (corresponding to line 4 of Table 4), it determines if the loop stops, that is, determining if the integer ι is greater than a preset value (e.g., 50 or another number), if the result is “Yes”, then the procedure ends at step 304. If the result of the step 303 is “No”, in step 305 (corresponding to lines 5-7 of Table 4), ∇ is computed, the matrix ν is computed based on the equation (7), and a temporary RMSE ε′ is computed based on X and ν^{T}ν. In step 306 (corresponding to line 8 of Table 4), it determines if the temporary RMSE ε′ is greater than the RMSE ε[ι−1] computed in the previous iteration. If the result of the step 306 is “Yes”, in step 307 (corresponding to lines 9-10 of Table 4), ν=V[ι]⊙∇^{β} is computed where ∇^{β} is elementwise exponentiation of a matrix and β is a scalar between 0.0 and 1.0 that is used to reduce the updating magnitude, and the temporary RMSE ε′ is computed based on X and ν^{T}ν. If the result of the step 306 is “No”, in step 308 (corresponding to lines 12-13 of Table 4), V[ι]=ν, and RMSE ε[ι−1] is updated based on X and V[ι]^{T}V[ι]. In step 309 (corresponding to line 14 of Table 4), ε[ι]=ε[ι−1] and ι=ι+1 are computed.

### Second Embodiment

The objective function of the second embodiment is identical to that of the first embodiment. The Projected Gradient-Based Direct Method is proposed in the embodiment in which the second-order differentiation is considered (i.e., considering Rates of the Change of Gradients) when updating the matrix V. Therefore, Hessian Matrix is computed based on the following equation (8).

$$\frac{1}{4} H = \frac{1}{4} \frac{Vec ( dE )}{Vec ( dV )} = ( {I}_{N} ⊗ V ) Diag ( Vec ( W ) ) ( {V}^{T} ⊗ {I}_{N} ) Ω + ( {I}_{N} ⊗ V ) + Diag ( Vec ( W ) ) ( {I}_{N} ⊗ {V}^{T} ) + ( W ⊙ ( {V}^{T} V ) ) ⊗ {I}_{D} - ( W ⊙ X ) ⊗ {I}_{D} \qquad ( 8 )$$

Vec(⋅) vectorizes a matrix by vertically stacking the columns of the matrix together. Diag(⋅) creates a diagonal matrix based on a vector. ⊗ denotes the operator of Kronecker Products. Ω is a permutation matrix based on Vec(V) such that ΩVec(V)=Vec(V^{T}). Based on the equation (6), the gradient is listed in the following equation (9), and the matrix V is updated based on the following equation (10).

Δ=−4V(W⊙X)+4V(W⊙(V^{T}V)) (9)

V_{d,n}=med{θ,V_{d,n}−ζΔ_{d,n},B_{d,n}} (10)

ζ is an iteration updating rate. Like the first embodiment, the unknown matrix V is fixed first and then the matrix W is computed based on the selected half quadratic function by looking up the function definition in Table 3. Next, the matrix V is computed based on the equations (9) and (10). The updating procedure is divided into a main procedure and a subprocedure. The main procedure is shown in the following Table 5, and the subprocedure is shown in Table 6.

TABLE 5
Projected Gradient-Based Direct Method-Main Procedure

| | Input: Symmetric matrix X |
|---|---|
| | Output: V |
| 1 | Initialize ν = V[0] |
| 2 | Compute RMSE ε[0] between X and V[0]^{T}V[0] |
| 3 | Set ι=1 |
| 4 | Execute lines 5-16 until ι is greater than a preset value |
| 5 | Compute Δ |
| 6 | Compute H |
| 7 | Compute δ = Norm(Δ(Δ < 0 or V > 0)) |
| 8 | If δ < Threshold |
| 9 | Stop the loop |
| 10 | Compute the subprocedure and set the result as ν |
| 11 | Compute a temporary RMSEε′ based on X and ν^{T}ν |
| 12 | If ε′ ≤ ε[ι−1] |
| 13 | V[ι] = ν |
| 14 | Update RMSE ε[ι−1] based on X and V[ι]^{T}V[ι] |
| 15 | ε[ι] = ε[ι−1] and ι = ι+ 1 |
| 16 | Go back to line 4 |

TABLE 6
Projected Gradient-Based Direct Method-Subprocedure

| | Input: X, V, Δ, H |
|---|---|
| | Output: V |
| 1 | Initialize ι=1 and get scale from the range 0.0 to 1.0 |
| 2 | Execute lines 2-20 until ι is greater than a preset value |
| 3 | Compute a temporary ν based on the equation (10) |
| 4 | δ = ν − V |
| 5 | a = Σ_{d=1}^{D}Σₙ₌₁^{N} (Δ ⊙ δ)_{d,n} |
| 6 | b = Σᵢ₌₁^{DN} ((H Vec(δ)) ⊙ Vec(δ))ᵢ |
| 7 | If (the weighted sum of a and b) < 0 |
| 8 | Set Flag = 1, otherwise Flag = 0 |
| 9 | If ιequals 1 |
| 10 | ζ = 1 − Flag |
| 11 | Previous V = V |
| 12 | If ζ equals 1 |
| 13 | If Flag equals 1 |
| 14 | Return V, otherwise ζ = ζ × scale |
| 15 | If ζ equals 0 |
| 16 | If ((1-Flag) or (ν equals Previous V) |
| 17 | V = Previous V, return V |
| 18 | Else ζ = ζ ÷ scale and Previous V = ν |
| 19 | ι=ι + 1 |
| 20 | Go back to line 2 |
| 21 | Return V |

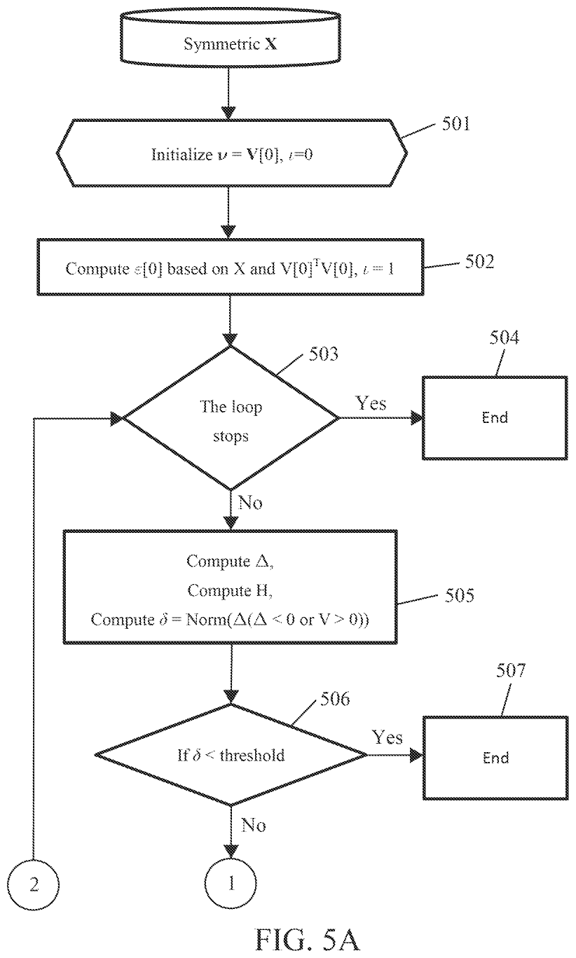

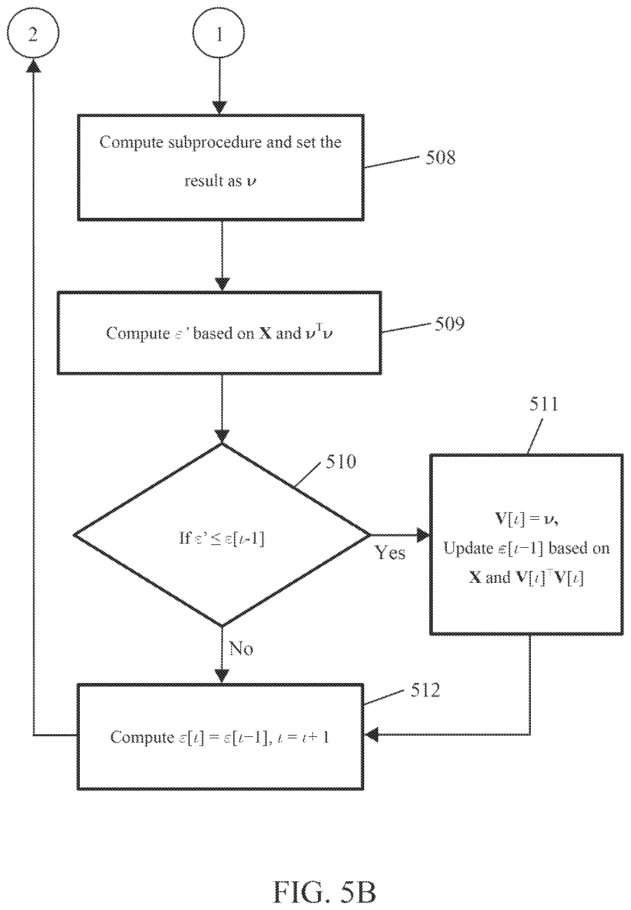

FIG. 5A and FIG. 5B are diagrams of a main procedure in accordance with the second embodiment. Referring to FIG. 5A, FIG. 5B and Table 5, step 501 corresponds to the first line of Table 5, step 502 corresponds to lines 2-3 of Table 5, and step 503 corresponds to line 4 of Table 5. The steps 501-504 are similar to the steps 301-304 of FIG. 3, and therefore the description will not be repeated. In step 505 (corresponding to lines 5-7 of Table 5), Δ is computed based on the equation (9), the matrix H is computed based on the equation (8), and δ=Norm(Δ(Δ<0 or V>0)) is computed in which δ is a real number, “Norm” represents L₂ norm, and the elements which do not satisfy the condition of (Δ<0 or V>0) in the matrix Δ are replaced with zeros.

In step 506 (corresponding line 8 of Table 5), it determines if the real number δ is less than a threshold. If the result is “Yes”, it means the updating magnitude is small enough, and therefore the procedure ends at step 507. If the result of the step 506 is “No”, in step 508 (corresponding to line 10 of Table 5), the subprocedure is computed and the returned result is set to be ν. In step 509 (corresponding to line 11 of Table 5), a temporary RMSE ε′ is computed based on X and ν^{T}ν. In step 510 (corresponding to line 12 of Table 5), it determines if ε′ is less than or equal to the RMSE ε[ι−1] computed in the previous iteration. If the result of the step 510 is “Yes”, it means the error is not increasing, and then in step 511 (corresponding o lines 13-14 of Table 5), V[ι]=ν is set and the RMSE ε[ι−1] is updated based on X and V[ι]^{T}V[ι]. In step 512 (corresponding to line 15 of Table 5), ε[ι]=ε[ι−1] is computed and ι=ι+1. Next, the procedure goes back to the step 503.

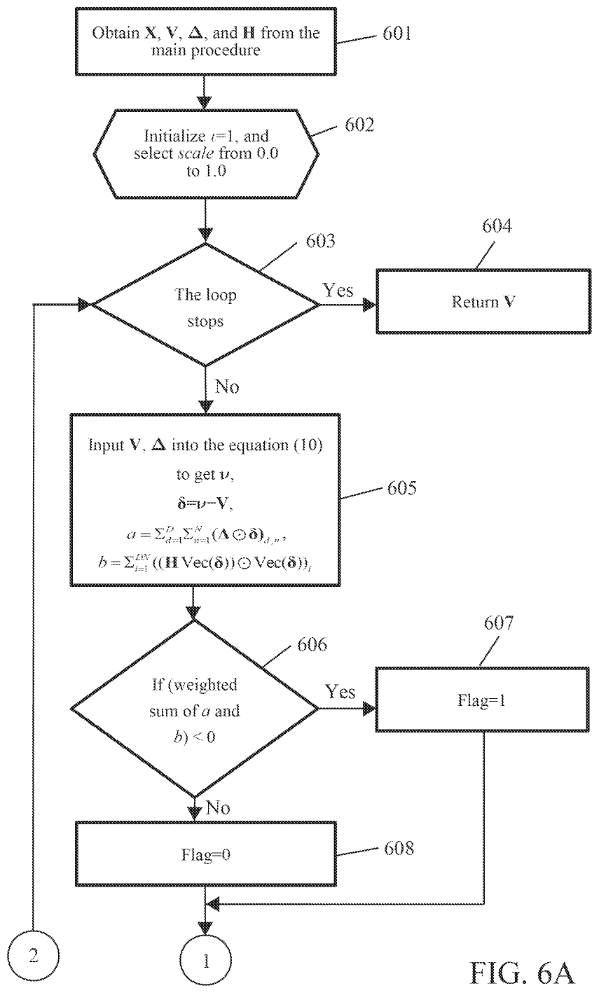

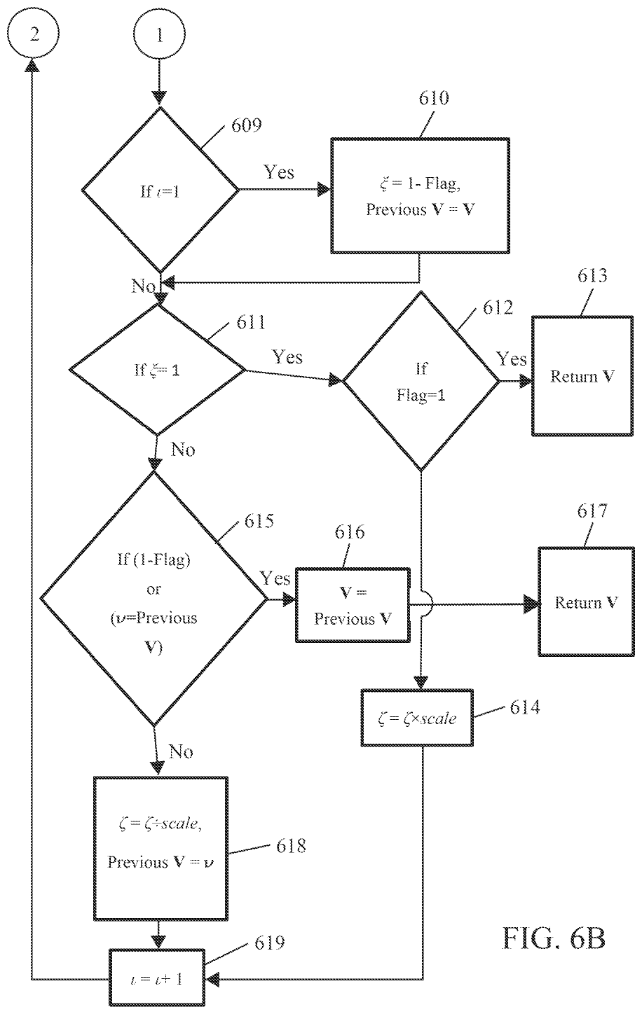

FIG. 6A and FIG. 6B are diagrams of a subprocedure in accordance with the second embodiment. Referring to FIG. 6A, FIG. 6B, and Table 6, In step 601, X, V, Δ, and H are obtained from the main procedure. In step 602 (corresponding to the first line of Table 6), ι=1 is initialized and a decimal scale is chosen from the range of 0.0 to 1.0 (not including 0.0 or 1.0). In step 603 (corresponding to line 2 of Table 6), it determines if the loop stops, that is, to determine if the integer ι. is greater than a preset value. If the result of the step 603 is “Yes”, in step 604 (corresponding to line 21 of Table 6), the subprocedure stops and the matrix V is returned. If the result of the step 603 is “No”, in step 605 (corresponding to lines 3-6 of Table 6), V and Δ are input into the equation (10) to get a temporary ν, δ=ν−V is computed, and a real number a=Σ_{d=1}^{D}Σₙ₌₁^{N}(Δ⊙δ)_{d,n} and a real number b=Σᵢ₌₁^{DN}((HVec(δ))⊙Vec(δ))ᵢ are computed. In step 606 (corresponding to line 7 of Table 6), it determines if a weighted sum of the real number a and the real number b is less than 0. To be specific, it determines if ω̅×a+(1−ω̅)×b is less than 0 where ω̅ is a decimal in the range from 0 to 1 (not including 0 or 1). If the result of the step 606 is “Yes”, in step 607 (corresponding to line 8 of Table 6), a Flag is set to be 1. If the result of the step 606 is “No”, in step 608 (corresponding to line 8 of Table 6), the Flag is set to be 0.

In step 609 (corresponding to line 9 of Table 6), it determines if the integer ι equals 1. If the result of the step 609 is “Yes”, in step 610 (corresponding to lines 10-11 of Table 6), a real number ξ is set to be 1−Flag, and Previous V=V. In step 611 (corresponding to line 12 of Table 6), it determines if the real number ξ equals 1. If the result of the step 611 is “Yes”, in step 612 (corresponding to line 13 of Table 6), it determines if Flag equals 1. If the result of the step 612 is “Yes”, in step 613 (corresponding to line 14 of Table 6), the subprocedure ends and the matrix V is returned. Otherwise in step 614 (corresponding to line 14 of Table 6), the real number ζ is decreased (e.g., ζ=ζ×scale is computed).

If the result of the step 611 is “No” (corresponding to line 15 of Table 6), in step 615 (corresponding to line 16 of Table 6), it determines if one of two conditions “1−Flag” and “ν equals Previous V” is true. If the result of the step 615 is “Yes”, in step 616 (corresponding to line 17 of Table 6) V=Previous V is set, and in step 617 (corresponding to line 17 of Table 6) the subprocedure ends and the matrix V is returned. If the result of the step 615 is “No”, in step 618 (corresponding to line 18 of Table 6), the real number ζ is increased (e.g., ζ=ζ÷scale is computed) and Previous V=ν is set. In step 619 (corresponding to line 19 of Table 6), ι=ι+1 is computed. The convergence speed of the second embodiment is faster than that of the first embodiment.

### Third Embodiment

The target matrix V^{T}V is set to be symmetric in the first and second embodiments, but the constraint is relaxed in the third embodiment. An asymmetry penalty constrained method is proposed in the embodiment. Given a N×N input symmetric matrix X, the aim to find two nonnegative unknown matrix U and V, of which the sizes are N×D and D×N respectively such that an error between a target matrix UV and the matrix X is minimized. To ensure symmetry, a penalty constraint is imposed in the objective function which is represented as the following equation (11).

$$min E = {min}_{{0 ⪯ U ⪯ A}_{0 ⪯ V ⪯ B}} \{ {\sum }_{n = 1}^{N} {\sum }_{m = 1}^{N} ϕ ( {( X - UV )}_{m , n} ) - λ {‖ {U}^{T} - V ‖}_{ℱ}^{2} \} \qquad ( 11 )$$

A and B are upper bounds. λ is a real number as a tuning parameter which may be defined by users. ∥⋅∥_{ℑ} is Frobenius Norm. To find the solution to the equation (11), alternating optimization process between W, U and V is adopted. Regarding U and V, taking the derivative of the equation (11) with respect to the matrix U_{n,d} and matrix V_{d,n} and then applying the multiplicative update rule yield the following equations (12) and (13).

$${U}_{n , d} = med \{ θ , {U}_{n , d} ⊙ \frac{{( ( X ⊙ W ) {V}^{T} + λ {V}^{T} )}_{n , d}}{{( ( \hat{X} ⊙ W ) {V}^{T} + λ U )}_{n , d}} , {A}_{n , d} \} \qquad ( 12 )$$

$${V}_{d , n} = med \{ θ , {V}_{d , n} ⊙ \frac{{( {U}^{T} ( W ⊙ X ) + λ {U}^{T} )}_{d , n}}{{( {U}^{T} ( W ⊙ \hat{X} ) + λ V )}_{d , n}} , {B}_{d , n} \} . \qquad ( 13 )$$

When the matrix A_{n,d} and matrix B_{n,d} are not set, there is no upper bound. In order to solve the problem of nonconvergence caused by oscillation of the RMSE during iterations, the iteration procedure of this embodiment is shown in the following Table 7.

TABLE 7
Asymmetry Penalty Constrained Method

| | Input: Symmetric matrix X |
|---|---|
| | Output: U and V |
| 1 | Initialize μ = U[0], ν = V[0], and ι=0 |
| 2 | Compute RMSE ε[0] based on X and U[0]V[0] |
| 3 | Set ι=1 |
| 4 | Execute lines 5-17 until ι is greater than a preset value |
| 5 | Compute W[ι] |
| 6 | Compute μ based on the equation (12) |
| 7 | Compute a temporary ε′ based on X and μV[ι−1] |
| 8 | If ε′ ≤ ε[ι−1] |
| 9 | U[ι] = μ |
| 10 | Update RMSE ε[ι−1] based on X and U[ι]V[ι−1] |
| 11 | Compute ν based on the equation (13) |
| 12 | Compote temporary ε' based on X and U[ι]ν |
| 13 | If ε′ ≤ ε[ι−1] |
| 14 | V[ι]= ν |
| 15 | Update RMSE ε[ι−1] based on X and U[ι]V[ι] |
| 16 | ε[ι] = ε[ι−1] and then ι = ι + 1 |
| 17 | Go back to line 4 |

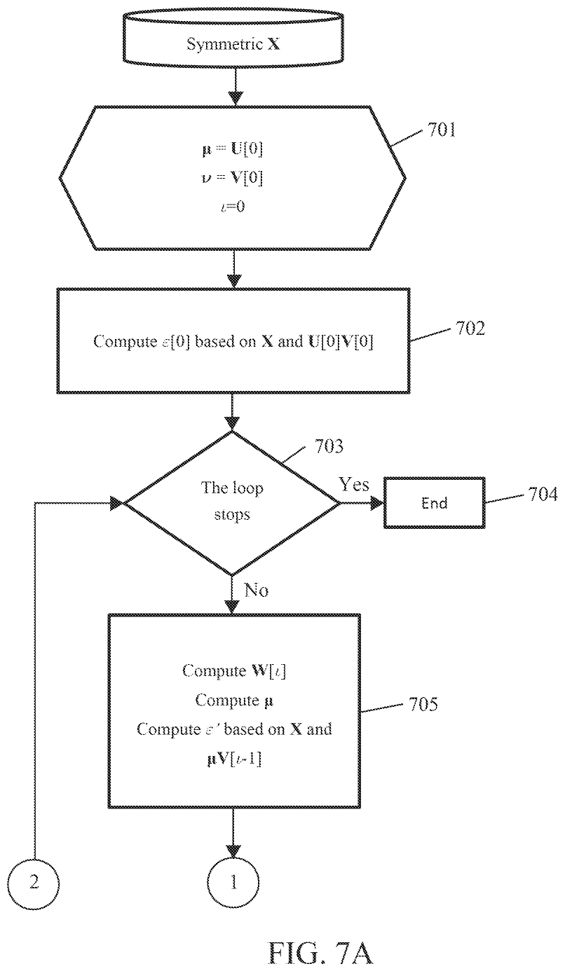

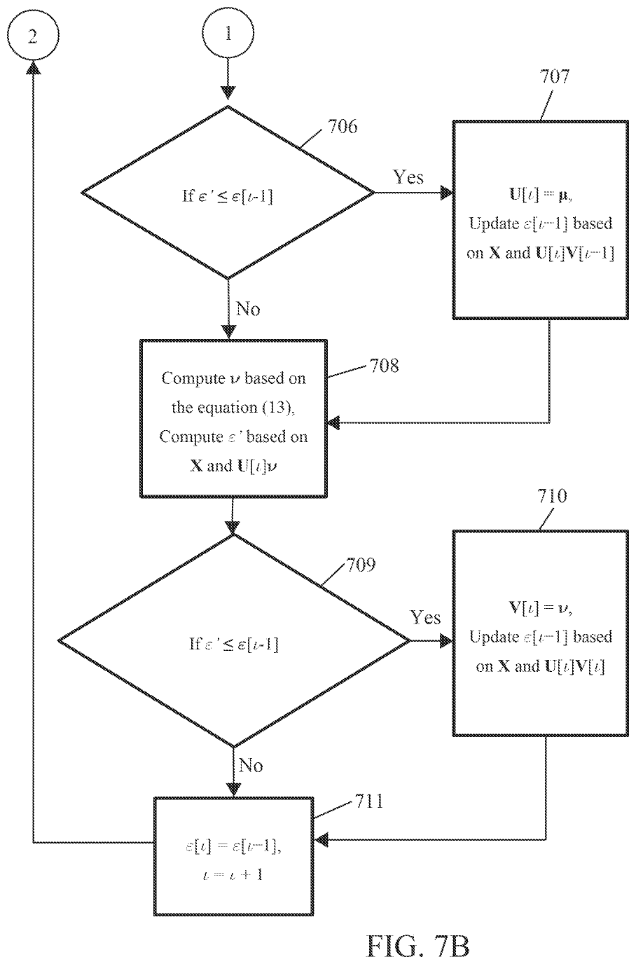

FIG. 7A and FIG. 7B are diagrams of a flow chart of an iteration procedure in accordance with the third embodiment. Referring to FIG. 7A, FIG. 7B, and Table 7, in step 701 (corresponding to the first line of Table 7), μ=U[0], ν=V[0], and ι=0 are initialized. In step 702 (corresponding to lines 2-3 of Table 7), RMSE ε[0] is computed based on X and U[0]V[0], and ι=1. In step 703 (corresponding to line 4 of Table 7), it determines if the integer ι is greater than a preset value. If “Yes” then the procedure ends in step 704, otherwise in step 705 (corresponding to lines 5-7 of Table 7), W[ι] is computed by looking up the function definition in Table 3, a matrix p is computed based on the equation (12), and a temporary ε′ is computed based on X and μV[ι−1].

In step 706 (corresponding to line 8 of Table 7), it determines if ε′ is less than or equal to the RMSE ε[ι−1] which is computed in the previous iteration. If the result of the step 706 is “Yes”, in step 707 (corresponding to lines 9-10 of Table 7), U[ι]=μ, and RMSE ε[ι−1] is updated based on X and U[ι]V[ι−1]. In step 708 (corresponding to lines 11-12 of Table 7), a temporary ν is computed based on the equation (13), and ε′ is computed based on X and U[ι]ν. In step 709 (corresponding to line 13 of Table 7), it determines if ε′ is less than or equal to the RMSE ε[ι−1] which is computed in the previous iteration. If the result of the step 709 is “Yes”, in step 710 (corresponding to lines 14-15 of Table 7), V[ι]=ν is computed and RMSE ε[ι−1] is updated based on X and U[ι]V[ι]. In step 711 (corresponding to line 16 of Table 7), ε[ι]=Σ[ι−1] and ι=ι+1 are computed.

In the first to third embodiments described above, the procedures ensure that the error can converge, that is, the error will not become larger so that the imputation quality can be improved. The advantages of the present disclosure include the use of half quadratic optimization to fill in the continuous null values of the symmetric matrix with substituted values. Compared with Latent Component-Based Methods and Symmetric Matrix Completion, this disclosure does not use norms that are susceptible to continuous null blocks or outliers while symmetric data is handled. Compared with the symmetric regression method, the present disclosure improves the shortcomings that the regression cannot run when there are null values in each attribute. Compared with the symmetric K-nearest neighbor algorithm, the present disclosure improves the shortcoming of the need for finding the K-nearest neighbor samples, and thus the computation is reduced especially for big data.

The error used in the above-mentioned embodiments is root mean square errors, but normalized root mean square errors, average absolute errors, coefficients of determination, “1 minus cosine similarity” or other suitable errors may be adopted in other embodiments.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims.

What is claimed is:

1. An imputation method for an electrical device, the imputation method comprising:
obtaining an input symmetric matrix which comprises a plurality of continuous null values;
taking a difference between the input symmetric matrix and a target matrix as an input of a half quadratic function to form an objective function; and
performing an optimization algorithm according to the objective function to obtain elements of the target matrix.

2. The imputation method of claim 1, wherein the objective function is represented as an equation (1):
$$\begin{matrix}min E = {min}_{0 ⪯ V ⪯ B} {\sum }_{n = 1}^{N} {\sum }_{m = 1}^{N} ϕ ( {( X - {V}^{T} V )}_{m , n} ) \\ = {min}_{0 ⪯ V ⪯ B} \{ {\sum }_{m = 1 , n = 1} ( {W}_{m , n} ⊙ {( X - {V}^{T} V )}_{m , n}^{2} + φ ( {W}_{m , n} ) ) \}\end{matrix} \qquad ( 1 )$$
wherein X is the input symmetric matrix, V is an unknown matrix, V^{T}V is the target matrix, ϕ(⋅) is the half quadratic function, B is an upper bound, N is a positive integer, W is a matrix consisting of nonnegative auxiliary scalars, and the half quadratic function is selected from a plurality of candidate half quadratic functions.

3. The imputation method of claim 2, further comprising:
fixing the unknown matrix V, and computing the matrix W according to a selected one of the candidate half quadratic functions by a lookup table approach; and
in an iteration procedure, computing the unknown matrix V according to an equation (2):
$${V}_{d , n} = med \{ θ , {V}_{d , n} ⊙ {( ( 1 - η ) {1}_{D \times N} + η \frac{V ( W ⊙ X )}{V ( W ⊙ ( {V}^{T} V ) )} )}_{d , n} , {B}_{d , n} \} \qquad ( 2 )$$
wherein θ is a positive number, η is an iteration updating rate, and med(⋅) is a median function.

4. The imputation method of claim 3, further comprising:
in each iteration of the iteration procedure, computing a matrix ν according to the equation (2), and computing a temporary error according to the input symmetric matrix X and a matrix ν^{T}ν;
reducing an updating magnitude if the temporary error is greater than an error computed in a previous iteration.

5. The imputation method of claim 2, further comprising:
fixing the unknown matrix V, and computing the matrix W according to a selected one of the candidate half quadratic functions by a lookup table approach; and
in an iteration procedure, computing the unknown matrix V according to equations (3) and (4):
Δ=−4V(W⊙X)+4V(W⊙(V^{T}V)) (3)
V_{d,n}=med{θ,V_{d,n}−ζΔ_{d,n},B_{d,n}} (4)
wherein θ is a positive number, ζ is an iteration updating rate, and med(⋅) is a median function.

6. The imputation method of claim 1, wherein the objective function is represented as an equation (5):
$$min E = {min}_{{0 ⪯ U ⪯ A}_{0 ⪯ V ⪯ B}} \{ {\sum }_{n = 1}^{N} {\sum }_{m = 1}^{N} ϕ ( {( X - UV )}_{m , n} ) - λ {‖ {U}^{T} - V ‖}_{ℱ}^{2} \} \qquad ( 5 )$$
wherein X is the input symmetric matrix, U and V are unknown matrices, UV is the target matrix, ϕ(⋅) is the half quadratic function, A and B are upper bounds, N is a positive integer, λ is a real number, and the half quadratic function is selected from a plurality of candidate half quadratic functions,
wherein the imputation method further comprises:
fixing the unknown matrix V, and computing a matrix W according to a selected one of the candidate half quadratic functions by a lookup table approach; and
in an iteration procedure, computing the unknown matrix U and the unknown matrix V according to equations (6) and (7):
$$\begin{matrix}{U}_{n , d} = med \{ θ , {U}_{n , d} ⊙ \frac{{( ( X ⊙ W ) {V}^{T} + λ {V}^{T} )}_{n , d}}{{( ( \hat{X} ⊙ W ) {V}^{T} + λ U )}_{n , d}} , {A}_{n , d} \} & ( 6 ) \\ {V}_{d , n} = med \{ θ , {V}_{d , n} ⊙ \frac{{( {U}^{T} ( W ⊙ X ) + λ {U}^{T} )}_{d , n}}{{( {U}^{T} ( W ⊙ \hat{X} ) + λ V )}_{d , n}} , {B}_{d , n} \} . & ( 7 )\end{matrix}$$
wherein θ is a positive number, and med(⋅) is a median function.

7. An electrical device comprising:
a memory storing a plurality of instructions;
a processor configured to execute the instructions to perform a plurality of steps:
obtaining an input symmetric matrix which comprises a plurality of continuous null values;
taking a difference between the input symmetric matrix and a target matrix as an input of a half quadratic function to form an objective function; and
performing an optimization algorithm according to the objective function to obtain elements of the target matrix.
